(19) United States
(12) Patent Application Publication
(10) Pub. No.: US 2005/0103836 A1
(43) Pub. Date: May 19, 2005

(54) Payment system

(75) Inventor: Paul Stephen Tolley, Cheshire (GB)

Correspondence Address: WATTS HOFFMANN CO., L.P.A., PO BOX 99839, Cleveland, OH, 44199-0839, US

(73) Assignee: Netcard Cash Limited

(21) Appl. No.: 11/009,118

(22) Filed: Dec. 10, 2004

Related U.S. Application Data
(63) Continuation-in-part of application No. 09/722,913, filed on Nov. 27, 2000, now abandoned.

(30) Foreign Application Priority Data
Nov. 26, 1999 (GB) 9927939.0
Jan. 11, 2000 (GB) 0000433.3

(51) Int. Cl. G06F 17/60

(52) U.S. Cl. 235/379

(57) ABSTRACT

A payment system, includes a plurality of purchasing units each associated with a unique identification number. The purchasing units can be purchased, and their existence is stored in central database. The purchasing units can be spent for instance over the Internet, and at this time, the purchasing units are redeemed by sending an appropriate signal including the unique identification number to the central database by the receiver of the payment.

### FIELD OF THE INVENTION

The present invention relates generally to payment devices and methods, and, more particularly, to a cash alternative device and method capable of purchasing goods or services.

### BACKGROUND OF THE INVENTION

There is an increasing concern for identity fraud in today's digital world. Highly susceptible to such theft are products and services purchased through mail order, over the telephone, and the Internet. In particular, such concern is exacerbated because of the exponential growth in the number of purchases made over the Internet each day. Conventionally, purchases over the Internet are usually paid for by credit card. It is often not considered desirable to provide credit card details for such purposes as they may be fraudulently used by an unauthorized person. This can be a particular fear with the Internet where it can be very difficult to identify the address and often even the location of a party offering a service or product. Furthermore, many people do not wish or cannot have credit cards, for instance as they may exceed their credit limit, may have been refused credit, or may be too young.

Credit cards are issued with significantly high lines of credit ranging in the thousands to tens-of-thousands of dollars without any method of controlling or reducing the amount available. In addition, the manner in which credit cards are issued make it impossible to transfer the purchasing power to another individual or limit another individuals purchasing power. As such, the prior art precludes flexible purchasing options that can be tailored for an individual's needs and preferences.

What is needed is a flexible and secure cash alternative payment system that allows purchasers to buy goods and services while catering to the individual's personal purchasing preferences.

### SUMMARY OF THE INVENTION

The present invention is directed to a method and a system for making a secured, yet flexible payment for the purchasing of goods and services. The payment system comprises a plurality of purchasing units in an intangible electronic format, which can be used like digital currency for purchasing goods and services. The purchasing units are activated after being electronically issued, and can be cancelled in part or all when spent by a user of the payment system.

The purchasing units are created, redeemed, and assigned a number through an account established by the user. The user provides personal information and deposits currency into the account that corresponds to the number of purchasing units. The user then creates his or her own unique identification number. The payment system is capable of making a secured payment by verifying the user's unique identification number assigned to the purchasing units.

The payment system includes a number of flexible features, such as the user's ability to securely transfer purchasing units to another individual by creating a new account and new unique identification number. The payment system also allows the user to combine two or more purchasing units comprising more than one unique identification number into a single unique identification number. The user also has the option of converting the purchasing units back into a corresponding amount of currency. The purchasing units remain in an electronic form and are capable of being spent, transferred, combined, converted, or redeemed.

These and other objects, advantages, and features of the exemplary embodiment of the invention are described in detail in conjunction with the accompanying drawings.

### BRIEF DESCRIPTION OF THE DRAWINGS

FIG. 1 shows a simplified block diagram of a payment system constructed in accordance with an embodiment of the present invention;

FIG. 2 shows a flow chart of a method that can be used by the payment system of FIG. 1; and

FIG. 3 shows a block diagram of a payment system constructed in accordance with an embodiment of the present invention.

### DETAILED DESCRIPTION

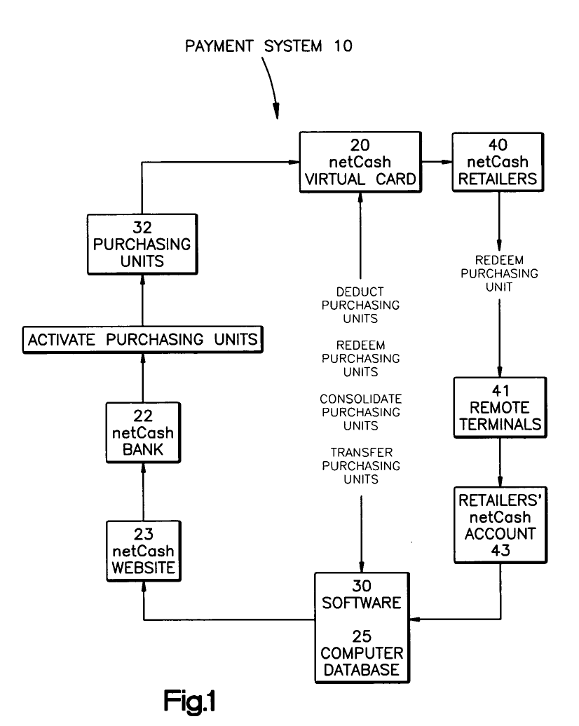

FIG. 1 shows a simplified embodiment of a payment system 10. The payment system depicted in FIG. 1 comprises a virtual account referred to as a netCash virtual card 20 that exists only in electronic form and contains an assigned account number. A user of the payment system can establish the netCash virtual card 20 from a netCash website 23. The establishment of a typical netCash virtual card 20 would require personal information such as date of birth and a unique identification code comprising any alphanumeric combination of characters designated by the user. In addition, the user is required deposit currency or equivalent funds into a netCash bank 22. The deposit can occur by electronically transferring funds from the user's existing bank accounts over the Internet or funds could be physically delivered to any netCash bank 22. Electronic purchasing units 32 are issued to the user in the amount deposited in the netCash bank 22. The purchasing units 32 are in an intangible electronic format that is capable of being read through a computer, CRT, television, phone, or personal organizer. As an example, the purchasing units can be conceptualized as digital currency and are assigned to the netCash virtual card 20, which shows an assigned account number, personal information, and unique identification number.

A computer database 25 contains software 30 capable of tracking account information, including assigning a number of purchasing units 32 based on the funds deposited into the netCash virtual card 20 by the user. In addition, the software 30 in the computer database 25 will adjust the netCash virtual card's fund balance when purchasing units 32 are spent, transferred, redeemed, or consolidated.

After establishing a netCash virtual card 20, the purchasing units 32 can then be used to purchase goods and services from an unlimited number of places that subscribe to the payment system. netCash subscribers or retailers 40 include retail and wholesale stores located throughout the world, from which purchases could be made by using the purchasing units 32 by mail, phone, Internet, or in person. Such retailers 40 would be connected to the payment system computer database 25 through any computer with an Internet connection shown in FIG. 1 as remote terminals 41. Any purchases made by the user would be entered by the retailer into their respective terminal for the amount of goods or services, and said amount would be deducted from the user's netCash virtual card 20 in the payment system's database 25 through the software 30. The payment system would then instantly pay the retailer in real time by transferring the required amount from the user's netCash virtual card 20 to the retailer's netCash account 43 for the goods and services purchased by the user.

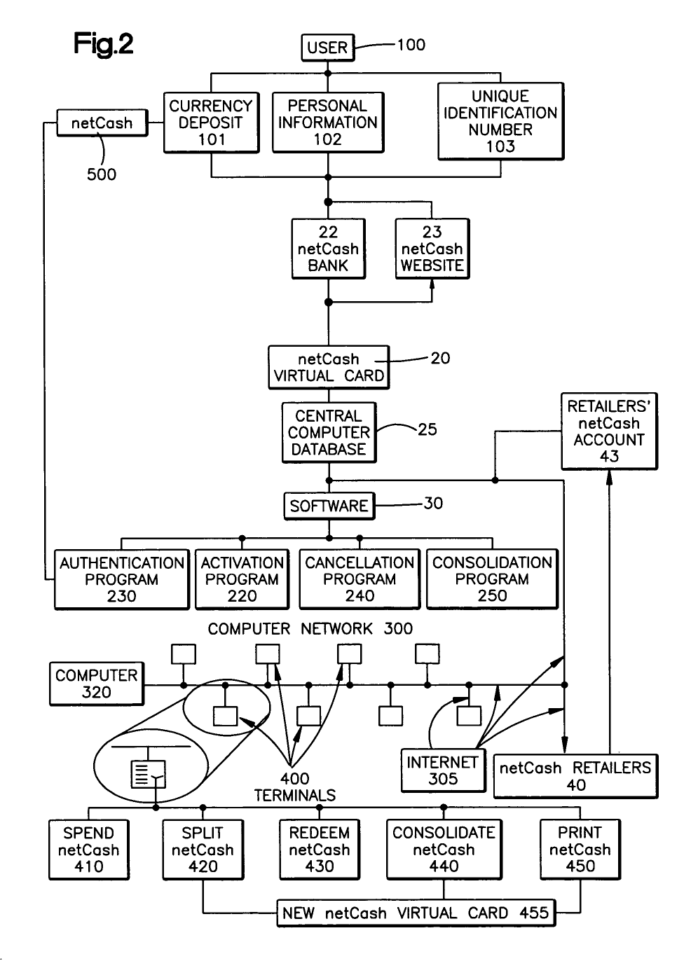

As shown in FIG. 2, a user 100 can create a netCash virtual card 20 from a netCash bank 22 or a netCash website 23. The netCash virtual card 20 is assigned after electronically or physically depositing currency 101 into the account, and entering personal information 102 into a central computer database 25. Alternatively, the user 100 can use any computer 320 connected to the Internet 305, visit a netCash website 23, and produce a paying slip by providing the personal information 102 discussed above. The user 100 can then transfer an electronic deposit or physically make a deposit at a netCash bank 22 and receive a receipt for the deposit, which would be activated online.

During the establishment of the netCash virtual card 20, the user creates his or her unique identification number 103, and enters the information into the central computer database 25. The deposited currency 103 is converted into purchasing units, also called netCash 500 in the described embodiment, which corresponds to the netCash virtual card 20 via the personal information 102 and unique identification number 103. netCash is a type of digital or virtual currency and the amount deposited is recorded and stored in the user's netCash virtual card 20 within the central computer database 25. netCash provides several unique and advantageous features over credit cards, cash transactions, or other traditional mediums of exchange, which will be discussed throughout this exemplary embodiment.

### Central Database, Software, and Computer Network

In the described embodiment, the central computer database 25 is connected to a computer network 300 via the Internet 305 to an unlimited number of netCash retailers 40, which accept the netCash purchasing system as a medium for exchange of their goods and services. It will be apparent to one of skill in the art that any number of networking techniques can be used to implement the netCash system. It should be noted that netCash users 10, retailers 40, netCash virtual cards 20, and retailer's netCash accounts 43 are not limited to a region or country, but could exist on websites found on the Internet, or physical locations throughout the world on all continents and in an unlimited number of countries. Further, the netCash payment system can also exist wherever there is a connection to the Internet 305.

Software 30 in the central database 25 comprises an activation program 220, which activates the user's netCash virtual card 20 once the netCash virtual card is established and the deposit is authenticated. The software further comprises an authentication program 230 that insures the user or individual is authorized to use the netCash virtual card 20 before making a transaction by verifying the user's unique identification number 103. The software 30 also comprises a cancellation program 240 that reduces the amount of purchasing units in the amount of the goods or services purchased by the user, as well a consolidation program 250 that enables a user to merge or divide netCash virtual cards 20.

The network of computers 300 contain a number of individual terminals 400 capable of Internet connection, so no specific establishment or place is required, as the payment system can be used by anyone at almost any location in the world.

### Features of the netCash System

Now that the user 100 has authenticated a netCash virtual card 20 and created his or her unique identification number 103, he or she can make purchases for goods and services on the Internet, over the phone, at retail, and wholesale establishments 40 up to the finite amount deposited in the netCash bank 22. This process of using the finite deposit as purchasing units in the described embodiment is one of the security features of netCash 500.

Spend netCash 410 is the designation for the payment system's ability to make purchases from retailers 40 of the netCash system. However, the purchases are limited to the finite amount deposited into the netCash virtual card 20. After a user makes a purchase, the software's cancellation program 240 reduces the user's netCash virtual card 20 balance in the amount of the goods or services purchased. Spend netCash 410 also provides the opportunity for users that do not own credit cards the ability to purchase products over the Internet that would otherwise be unavailable. In addition, spend netCash 410 purchases are made without the risks commonly associated with conventional credit cards.

As shown in FIG. 2, the user 100, after creating a netCash virtual card 20 can transfer a controlled amount of purchasing units to another individual, which is referred to as split netCash 420. Split netCash 420 offers a method for transferring purchasing units by electronic means and enables the user to control the amount of purchasing units to be transferred. Split netCash 420 requires the user to enter his or her account and unique identification number in order to establish a new netCash virtual card 455 with a new unique identification number. The user would then transfer a controlled finite amount of purchasing units to the new netCash virtual card 455 from his or her existing netCash virtual card 20. The new netCash virtual card 455 is then capable of being securely transferred to another individual electronically.

There is no limit to the number of times the virtual card 20 can be split using split netCash 420. For example, a netCash virtual card 20 with a purchasing unit balance of two dollars ($2.00) can be split into forty (40) five cent (0.05¢) netCash virtual cards without any additional cost to the user 100. Such application is useful when a precise amount of funds are owed to another individual or entity. If an amount of seven dollars and ninety-nine cents ($7.99) is owed, a netCash virtual card 20 can be created for that exact amount eliminating the risk of fraud or over payment.

Print netCash 450 is a method of recording the netCash virtual card's value, account number, and unique identification number in electronic form. Print netCash 450 can assist in the transferring of funds (split netCash 420) by emailing the print netCash 450 information to a new user. Such transfer requires online (via the Internet) confirmation that the print netCash 450 information is correct and verification that the netCash virtual card 20 is enabled and ready to use.

netCash also provides the user with the option of redeeming purchasing units from the netCash virtual card 20 in the form of real currency. This process of redemption is referred to as redeem netCash 430. The user can exercise redeem netCash from any terminal 400 on the computer network 300 or any computer connected to the Internet 305. The user would be required to enter his account number and unique identification number 103 through a computer connected to the Internet 305 or at a terminal 400. After the software's authentication program 230 found in the central computer database 25 verifies the user's identity, the user can redeem up to the total amount available in the virtual card's account at any netCash bank 22. The netCash retailer 40 would then pay the user the monies redeemed. Alternatively, the user could redeem the funds electronically by having the funds transferred to a separate account accessible to the user.

Another feature of the payment system is the user's ability to merge separate netCash virtual cards 20. This feature is called consolidate netCash 440. A user may desire the merging of two separate netCash virtual cards 20 for a number of reasons. For example, as a matter of personal convenience when two separate netCash virtual cards' 20 balances are low, the user may wish to consolidate the virtual cards to show one entire larger balance. Consolidate netCash 440 makes this possible through the software's consolidation program 250. The consolidation program then merges the funds into either a new 455 or existing virtual card 20.

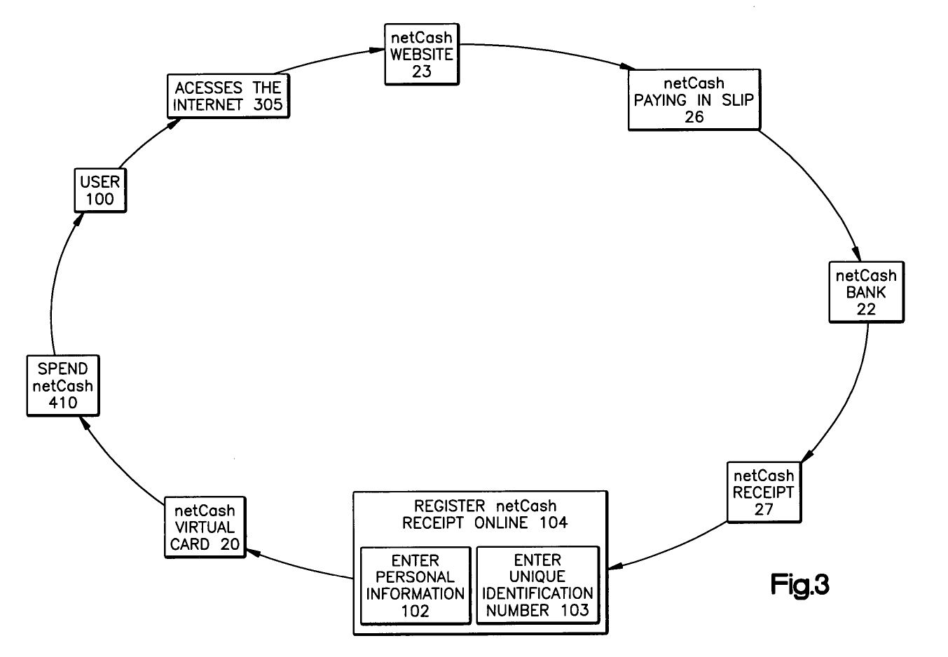

FIG. 3 depicts yet another method of establishing a netCash virtual card 20. First, the user 100 would visit a netCash website 23 via any computer with an Internet connection 305. A paying in slip 26 is then produced from the netCash website 23. Thereafter, the user can visit a netCash bank 22 were the paying in slip 26 and currency 101 are presented to a representative of the bank.

The netCash bank 22 creates and provides the user 100 with a netCash receipt 27 in return for the deposited amount of currency 101. The user 100 then registers the netCash receipt 27 information online, by entering personal information 102 and selecting a unique identification number 103, thus establishing a new netCash virtual card 20. All the features of the netCash system discussed above are now available to the user 100, including spend netCash 410.

Although the embodiments have been described with a certain degree of particularity, it should be understood that various changes can be made by those skilled in the art without departing from the spirit or scope of the invention hereinafter claimed.

1. A payment system comprising:
a plurality of purchasing units in an intangible electronic format that represent a corresponding amount of currency;
a purchasing unit activator that activates the purchasing units once said purchasing units are electronically issued; and
a purchasing unit redeemer that cancels part or all of the purchasing units when part or all of the purchasing units are spent.

2. The payment system of claim 1, wherein the purchasing units are assigned an identification number upon activation.

3. The payment system of claim 2, wherein the redeemer verifies the purchasing unit by checking a user identification number with the assigned identification number.

4. The payment system of claim 1, wherein purchasing units comprise a unique identification in an intangible electronic format capable of being read through a computer, CRT, television, phone, or personal organizer.

5. The payment system of claim 2, wherein a purchaser selects their own unique identification number for said purchasing units.

6. The payment system of claim 2, wherein a purchaser securely transfers purchasing units to another by creating a new account and new unique identification number.

7. The payment system of claim 2, wherein two or more purchasing units comprising different identification numbers are combined to possess only one unique identification number.

8. The payment system of claim 1, wherein purchasing units are redeemed for the purchase of goods and services in retail or wholesale stores and on the Internet.

9. The payment system of claim 1, wherein purchasing units are exchanged or converted into a corresponding amount of currency.

10. The payment system of claim 1, wherein an account for said purchasing units can be created entirely over the Internet.

11. A method that transacts a purchase of goods or services comprising:
depositing an amount of currency into an account;
activating a number of purchasing units in intangible electronic format that corresponds to the amount of currency deposited;
redeeming a subset of the purchasing units to purchase goods or services from a seller, wherein the subset of purchasing units is applied toward the purchase price of the goods or services; and
transferring currency in the amount of the redeemed purchasing units from the account to the seller.

12. The method that transacts a purchase of goods or services of claim 11 comprising assigning a unique identification number to the account containing said purchasing units.

13. The method that transacts a purchase of goods or services of claim 11 wherein the user's identity is authenticated before making a transaction by verifying the user's unique identification number.

14. The method that transacts a purchase of goods or services of claim 11 comprising spending purchasing units on goods and services and wherein the amount of purchasing units in said account are reduced by the value of the goods or services purchased.

15. The method that transacts a purchase of goods or services of claim 11 comprising transferring a controlled amount of purchasing units to another individual electronically.

16. The method that transacts a purchase of goods or service of claim 11 comprising redeeming purchasing units from said account in the form of real currency.

17. The method that transacts a purchase of goods or service of claim 11 comprising merging two or more separate accounts into a single new or existing account with one unique identification number.

18. Computer readable media having computer-executable instructions stored thereon for performing a method that transacts a purchase of goods or services, the method comprising:
depositing an amount of currency into an account;
activating a number of purchasing units in intangible electronic format that corresponds to the amount of currency deposited;
redeeming a subset of the purchasing units to purchase goods or services from a seller, wherein the subset of purchasing units is applied toward the purchase price of the goods or services; and
transferring currency in the amount of the redeemed purchasing units from the account to the seller.

19. The computer readable media of claim 18 wherein the method comprises assigning a unique identification number to the account containing said purchasing units.

20. The computer readable media of claim 18 wherein the user's identity is authenticated before making a transaction by verifying the user's unique identification number.

21. The computer readable media of claim 18 wherein the method comprises spending purchasing units on goods and services and wherein the amount of purchasing units in said account are reduced by the value of the goods or services purchased.

22. The computer readable media of claim 18 wherein the method comprises transferring a controlled amount of purchasing units to another individual electronically.

23. The computer readable media of claim 18 wherein the method comprises redeeming purchasing units from said account in the form of real currency.

24. The computer readable media of claim 18 wherein the method comprises merging two or more separate accounts into a single new or existing account with one unique identification number.
